(19) United States
(12) Patent Application Publication
(10) Pub. No.: US 2006/0191205 A1
(43) Pub. Date: Aug. 31, 2006

(54) Door operator drive system

(76) Inventors: Willis J. Mullet, Gulf Breeze, FL (US); Donald B. Kyle, Pace, FL (US)

Correspondence Address: Phillip L. Kenner;RENNER, KENNER, GREIVE, BOBAK, TAYLOR & WEBER, Fourth Floor, First National Tower, Akron, OH, 44308-1456, US

(21) Appl. No.: 11/067,828

(22) Filed: Feb. 28, 2005

(51) Int. Cl. E05F 15/00

(52) U.S. Cl. 49/199; 49/200

(57) ABSTRACT

A drive system for a door (10) having an operator (35) and a counterbalance system (25). A drive tube (27) of the counterbalance system (25) interconnects the operator (35) and the door (10). A gear assembly (65) of the operator (35) engages the drive tube (27) for transferring rotational forces from the operator (35) to the drive tube (27). An aperture (105) extends through the gear assembly (65), and a fastener (106) extends through the aperture (105) to deform the drive tube (105). The fastener (106) sufficiently deforms the drive tube (27) to permit transfer of operating torque of the operator (35) to the drive tube (27), but not to an extent that prevents the gear assembly (65) from being removed from the drive tube (27).

### TECHNICAL FIELD

The present invention generally relates to upwardly acting barriers, and to an operator system used to open and close upwardly acting doors. More particularly, the present invention relates to an operator system that interacts with the drive tube or axle of a counterbalance system to open and close a sectional door. More specifically, the present invention relates to an operator system employing a gear assembly which can be assembled around a drive tube or axle to operatively interconnect the operator system with a counterbalance system.

### BACKGROUND ART

To facilitate the retrofit of an operator system on the drive tube of an existing counterbalance system, it has been desirable to configure the operator system to engage the drive tube without disassembling the counterbalance system. To that end, gear assemblies attached to the drive tube, and operatively interconnected with the motor of the operator system have been provided. These gear assemblies define bores for accommodating the drive tube. For example, the gear assemblies include removable gear segments provided to selectively open the bore to receive the drive tube. Once the gear assemblies are assembled around the drive tube, fasteners are inserted through apertures in the gear assemblies. These fasteners impinge the drive tube to provide a clamping force that secures the gear assemblies in position on the drive tube. However, if the fasteners are too long, aggressive clamping force may be applied against the drive tube. Such a clamping force can significantly deform the drive tube. For example, impingement of such fasteners can collapse the drive tube at or adjacent the area of contact, and enlarge the drive tube around its perimeter and along its axial length adjacent the gear assemblies. The bulges caused by such enlargement can trap the gear assemblies in position on the drive tube and prevent their axial movement therealong.

As seen in the FIG. 6, an exemplary gear assembly 120 having a removable gear segment 122 is assembled around a drive tube 123. The gear assembly 120 includes a projection 124 provided with an aperture 125 therethrough for receiving a locking faster 126. When the locking faster 126 is tightened within the aperture 125, the locking faster 126 impinges against the drive tube 123 in the area generally indicated by the numeral 130 in FIGS. 6 and 6A. Due to the length of the locking faster 126, such impingement significantly deforms the drive tube 123. Due to significant deformation, the drive tube 123 collapses, a large recess 131 is created at the area indicated in FIGS. 6 and 6A, and bulges are created around and along the drive tube 123 at the areas generally indicated by the numerals 132, 133, 134 and 135. The bulges at 132, 133, 134 and 135 prevent axial movement of the gear assembly 120 along the drive tube 123, and, resultantly, can inhibit removal, servicing, and replacement of the gear assembly 120. Moreover, the recess created at 131 may weaken the drive tube 123 such that it is rendered unusable. As such, it is desirable to have a combined gear assembly and drive tube and a method for attaching the gear assembly to the drive tube where the gear assembly is securely attached to the drive tube, but significant deformation of the drive tube is prevented.

### DISCLOSURE OF THE INVENTION

It is therefore an object of the present invention to provide an operator drive system employing a gear assembly which can be securely attached to a drive tube. Another object of the present invention is to provide an operator drive system employing a gear assembly which can be retrofitted to a drive tube of an existing counterbalance system without dismounting or disassembling the counterbalance system. A further object of the present invention is to provide an operator drive system having a gear assembly including a removable portion so that the gear assembly can be assembled around a drive tube.

A still further object of the present invention is to provide an operator drive system having a gear assembly with a removable portion defining a radial slot allowing insertion of a drive tube. A yet further object of the present invention is to provide an operator drive system having a gear assembly attached to a drive tube so that torque can be transferred through the gear assembly to the drive tube, and such attachment only slightly deforms the drive tube.

In light of at least one of the foregoing objects, the present invention generally contemplates a drive system for a door having an operator and a counterbalance system. A drive tube of the counterbalance system interconnects the operator and the door. A gear assembly of the operator engages the drive tube for transferring rotational forces from the operator to the drive tube. An aperture extends through the gear assembly, and a fastener extends through the aperture to deform the drive tube. The fastener sufficiently deforms the drive tube to permit transfer of operating torque of the operator to the drive tube, but not to an extent that prevents the gear assembly from being removed from the drive tube.

A preferred exemplary door operator drive system incorporating the concepts of the present invention is shown be way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a rear perspective view of a door system including an operator according to the concepts of the present invention mounted on a drive tube and located within the lateral confines of a counterbalance system.

FIG. 2 is a top perspective view of the operator depicted in FIG. 1 showing a fragmentary portion of the drive tube extending through gear assemblies located at on the left-hand and right-hand sides of the operator housing.

FIG. 3 is an enlarged bottom perspective view of the left-hand gear assembly with a fragmentary portion of the drive tube extending therethrough.

FIG. 4 is an exploded top perspective view similar to FIG. 2 showing the drive tube removed, and the left-hand and right-hand gear assemblies dismantled to show additional details of the operator system.

FIG. 4A is an enlarged exploded top perspective view of the area of the operator indicated in FIG. 4 showing details of the left-hand gear assembly with a removable gear segment detached therefrom.

FIG. 4B is an enlarged top perspective view similar to FIG. 4A with a portion of the removable gear segment cut away and shown in section.

FIG. 4C is an enlarged exploded bottom perspective view of the left-hand gear assembly with the removable gear segment detached therefrom.

FIG. 5 is an end elevational view of the left-hand gear assembly attached to the drive tube of the counterbalance system shown in cross-section.

FIG. 5A is a cross-sectional view taken substantially along line 5A-5A of FIG. 5 showing the gear assembly attached to the drive tube.

FIG. 6 is a front elevational view of a prior art gear assembly attached to a drive tube of a counterbalance system.

FIG. 6A is a cross-sectional view taken substantially along Line 6A-6A of FIG. 6 showing the prior art gear assembly attached to the drive tube.

### BEST MODE FOR CARRYING OUT THE INVENTION

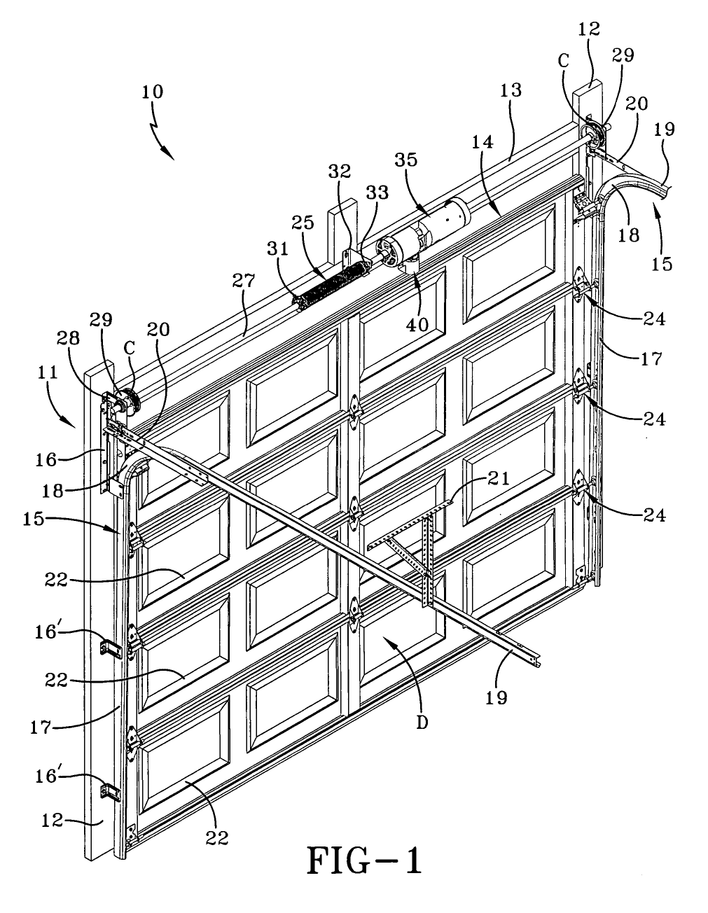

A door system, generally indicated by the numeral 10, is shown in FIG. 1. The door system 10 may be mounted on a framework, generally indicated by the numeral 11, that includes a pair of upstanding jambs 12 interconnected near their vertical upper extremities by a header 13. The generally inverted U-shaped framework 11 defines an opening 14 between the pair of upstanding jambs 12 and header 13.

Track assemblies, generally indicated by the numeral 15, may be mounted on the framework 11, for example, as by flag angles 16 and brackets 16′ that are fastened to jambs 12. Track assemblies 15 each include a generally vertical track section 17, an arc-shaped transitional track section 18 extending upwardly and rearwardly from the vertical track section 17, and a rearwardly extending generally horizontal track section 19. Additional support for the horizontal track section 19 may be provided in the form of horizontal angles 20 attached to the header 13, and hangers 21 attached to an overhead structure (not shown).

A door D is located between the track assemblies 15 and guided between open and closed positions thereby. The door D, depicted in FIG. 1, is shown in a closed vertical position and includes a plurality of panel sections 22 that are pivotally interconnected with one another by hinge assemblies 24. The number and size of panel sections 22 varies depending on the size of the door D.

A counterbalance system, generally indicated by the numeral 25, provides a counterbalancing force partially offsetting the weight of the door D to facilitate opening and closing of the door D in a manner known to persons skilled in the art. The counterbalance system 25 includes a coil spring 26 which is shown by way of example, and should not be considered as limiting the present invention to use with this particular type of counterbalance system. The counterbalance system 25 generally includes a drive tube 27 rotatably supported by support brackets 28 mounted to the framework 11. Cable drums 29 are mounted on drive tube 27 and rotatably fixed thereto. The cable drums 29 rotate with the drive tube 27, and include a cable C wound thereon. The cable C is attached to the door D to effect transfer of the counterbalancing force generated by the coil springs 26 to the door D.

The coil spring 25 is interconnected with the drive tube 27 at one end 31 and is interconnected with a fixed bracket 32 at the other end 33 to develop the counterbalancing force upon rotation of the drive tube 27. Thus, in a manner known to persons skilled in the art, the counterbalancing force is transferred to the door D through the drive tube 27 and cable drums 29 via cable C. In operation, the cable C is selectively wound and unwound as the door D is opened or closed, respectively, thereby maintaining the tension on the door D. As a result, relatively little force is needed to operate the door D. Thus, the door D may be manually operated or power operated by an operator as described herein.

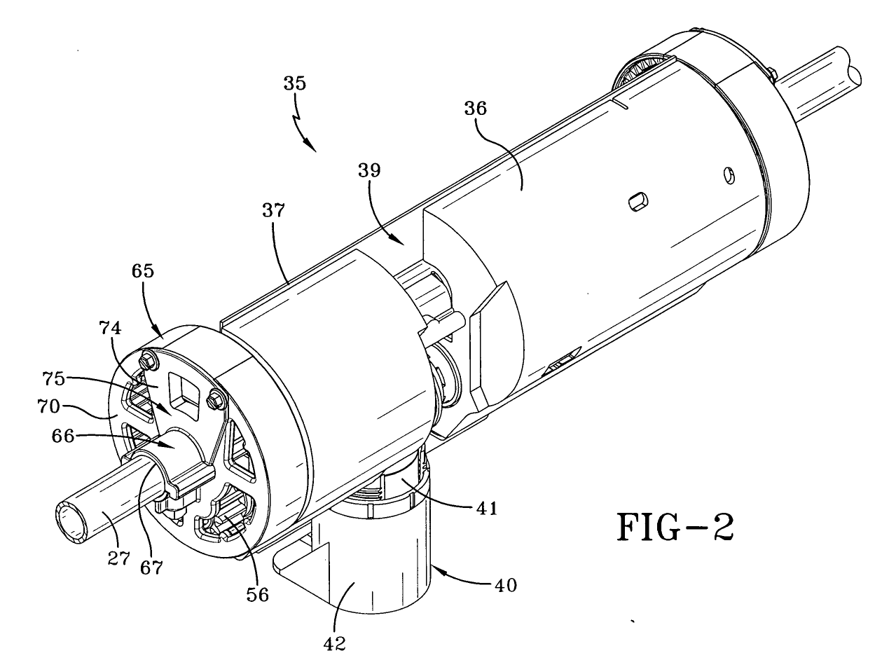

An operator 35 is mounted on the drive tube 27 and is operable therewith to open and close the door D. With reference to FIG. 2, the operator 35 generally includes a housing 36 that receives drive tube 27 therethrough, such that the operator 35 may be both located entirely between the track assemblies 15 and between the lateral extremities of the drive tube 27. As such, as shown in FIG. 1, the operator does not require additional space beyond the edges of the door D.

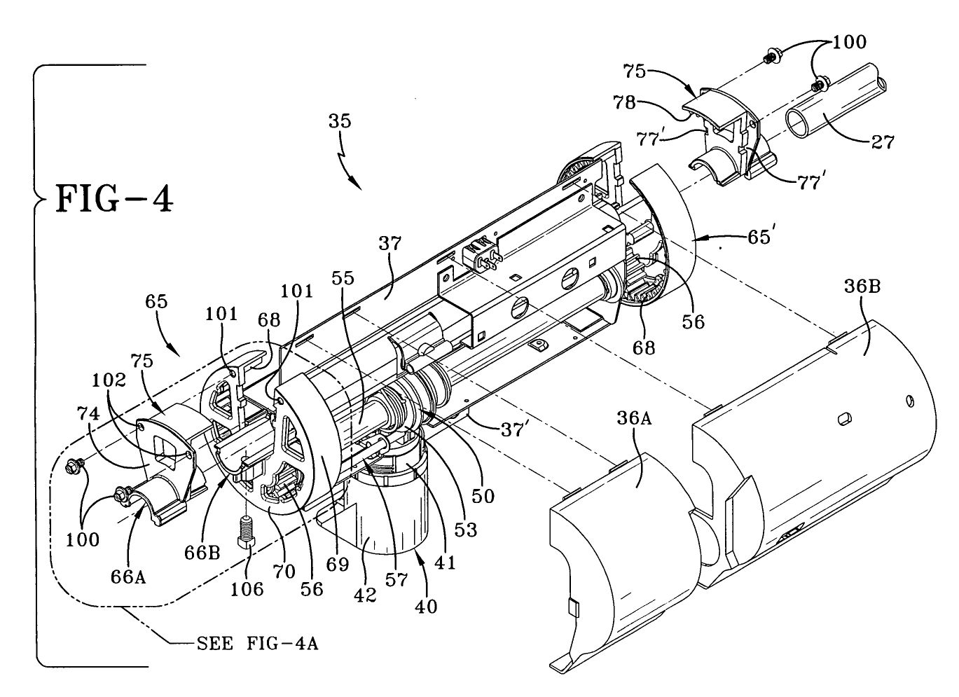

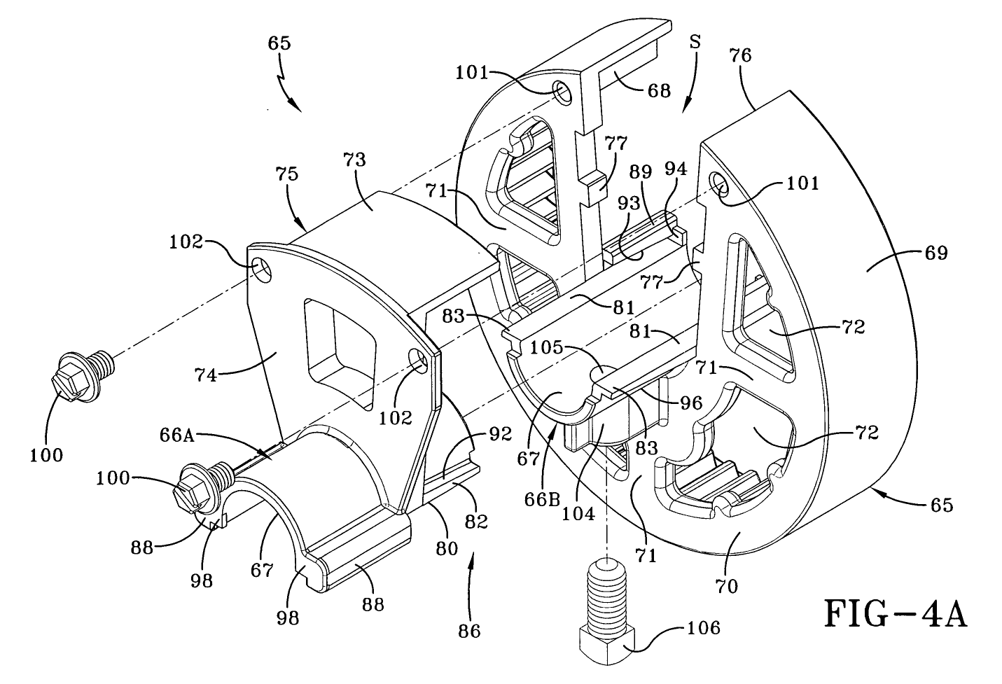

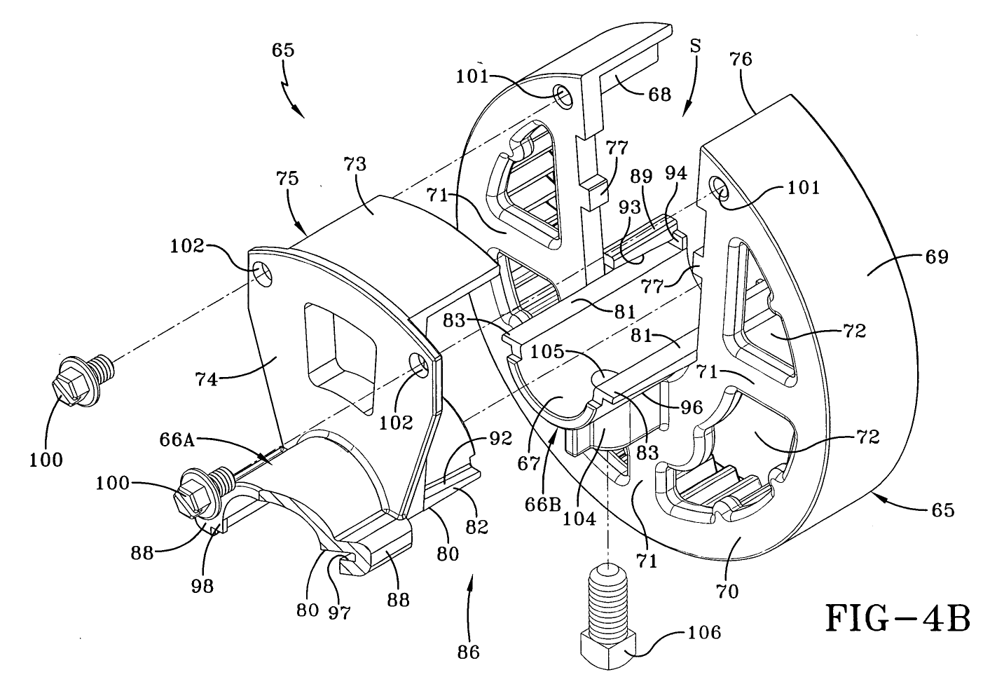

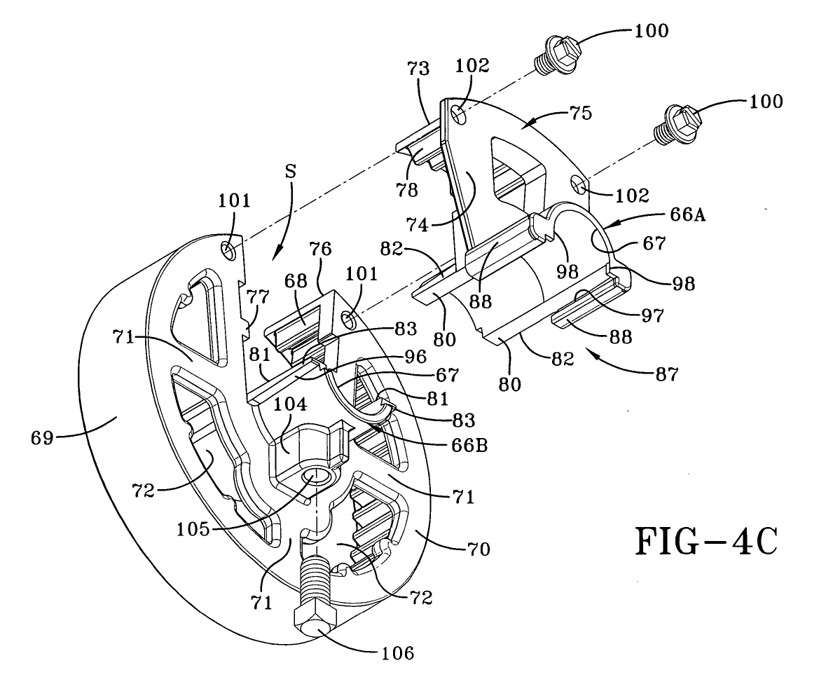

The housing 36 may be in the form of a hollow shell that attaches to an operator framework 37 having a mounting bracket 37′ that attaches the operator 35 to header 13 as by suitable fasteners (not shown). Housing 36 may be divided into first and second sections 36A, 36B, shown in FIG. 4, defining a gap, generally indicated by the numeral 39, therebetween to accommodate a pivoting motor assembly, generally indicated by the numeral 40.

The motor assembly 40, which may include a conventional electric motor 41 that is designed for stop, forward, and reverse rotation of a motor shaft (not shown) and, in turn, the drive tube 27. Although it will be appreciated that a non-pivoting operator motor may be used in the operator 35, the motor assembly 40 shown can pivot between a generally rearward horizontally extending position and the downwardly vertically extending position (FIG. 2). The motor assembly 40 may include a motor cover 42 that overlies the electric motor 41 and is generally cylindrical with a radial extension adapted to engage a portion of the door D when the door D is in a closed vertical position. In this way, the motor assembly 40 provides a positive stop against forcible opening of the door D by an intruder, weather conditions or the like. Such contact further is advantageous in effecting and maintaining sealing engagement of the door D with the door frame 11.

Referring to FIG. 4, the operator 35 includes a drive train enclosure, generally indicated by the numeral 50, supported within the operator framework 37 adjacent the motor assembly 40. As shown, drive train assembly 50 may extend generally in a direction perpendicular to the axis of the motor assembly 40. The drive train assembly 50 may accommodate a worm gear (not shown) attached to or cut into the shaft of the motor 41. The drive train assembly 50 also includes an open ended cylindrical journal 53 that seats internally thereof a worm wheel (not shown) that is at all times positioned in mating engagement with the worm gear.

A drive shaft 55 extends axially outward from the drive train assembly 50, and includes a drive gear 56 nonrotatably mounted thereon. As best shown in FIG. 4, the drive gear 56 may be mounted at a distal end of drive shaft 55 with a pivot control assembly, generally indicated by the numeral 57, carried on the drive shaft 55 located between the cylindrical journal 53 and the drive gear 56. The pivot control assembly 57 may be made in accordance with the concepts of the pivot control assembly disclosed in U.S. patent application Ser. No. 09/710,071, which was filed on Nov. 10, 2000 (a continuation-in-part of U.S. patent application Ser. No. 09/548,191, which was filed on Apr. 13, 2000), and is incorporated herein by reference.

In the embodiment shown, a pair of gear assemblies 65, 65′ are provided at either end of the operator 35. It will be appreciated that only a single gear assembly 65 may be used, and that only a single gear assembly 65 needs to be driven.

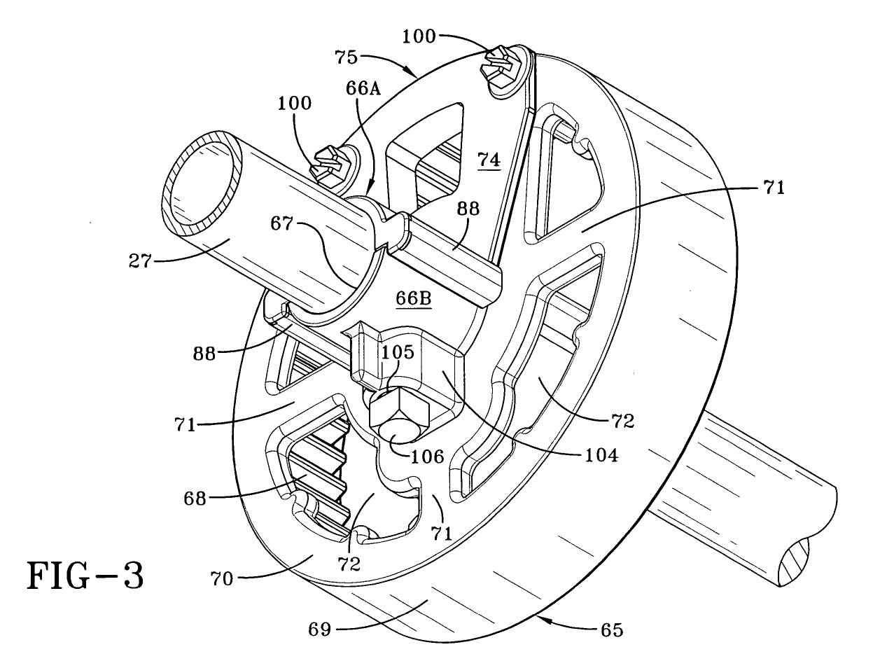

With reference to FIG. 3, it may be seen that gear assembly 65 is generally wheel-like in form, having a hub, generally indicated by the numeral 66 defining a bore 67 through which the drive tube 27 is received. At its periphery, gear assembly 65 includes a gear surface 68 adapted to mate with the drive gear 56, such that motor assembly 40 may cause rotation of the gear assembly 65. The gear surface 68 may be formed externally on the gear assembly 65, such that the drive gear 56 would be located on the outside of the gear assembly 65, or, as in the example shown, the gear surface 68 may formed internally. With the gear surface 68 formed internally, drive gear 56 is located on the interior side of the gear assembly 65 which reduces the likelihood of entrapment of articles between the drive gear 56 and gear surface 68. The gear surface 68 is supported on a generally cylindrical rim 69 that is supported in spaced relation from the hub 66 by an end wall 70, which may be solid or skeletal. When the end wall 70 is skeletal, as shown in the figures, the end wall 70 includes radially extending support members 71 that define openings 72 therebetween. As such, reference to “end wall” 70 encompasses any member or members that support the rim 69 on hub 66.

As best shown in FIGS. 4A, 4B, and 4C, the gear assembly 65 can include a removable portion to create a radial slot S allowing insertion of the drive tube 27 without having to disassemble the counterbalance system 25. That is, a portion of the hub 66, gear surface 68, and/or rim 69 can be made removable for opening the gear assembly 65 to create the radial slot S to allow insertion of the drive tube 27 into the bore 67. As such, the gear assembly 65 can be assembled around the drive tube 27, and, thereafter, can be located at various axial positions therealong without dismounting or disassembling the counterbalance system 25. In particular, the hub 66 can be divided into two halves 66A, 66B with one of the halves being removable to open the entire diameter of the bore 67. It will be appreciated that, if the bore 67 is larger than the drive tube 27 with which the operator 35 is used, a smaller portion of the hub 66 may be made removable. Furthermore, a portion of the rim 69 sufficiently large to receive drive tube 27 is made removable, such that the drive tube 27 passes through the rim 69 to be received in the hub half 66B that remains attached to the end wall 70. It will also be appreciated that the hub 66 and rim 69 may be removed and reassembled as separate components.

In the example depicted in the figures, the hub half 66A and a removable rim portion 73 of the rim 69 may be joined by a removable end wall portion 74 of the end wall 70, such that the hub half 66A and removable rim portion 73 are simultaneously removable. For purposes of simplicity, the hub half 66A, the removable rim portion 73, and the removable portion end wall portion 74 will be collectively referred to as a removable gear segment, generally indicated by the numeral 75 in the accompanying drawings. As such, the removable gear segment 75 is attached to the remainder of the gear assembly 65 so that the gear assembly can be assembled around the drive tube 27.

As best shown in FIGS. 4A, 4B, and 4C, the removable gear segment 75 is generally adapted to be attached to and removed from the gear assembly 65 in an axial direction. To help insure proper fit of the removable gear segment 75, and to help reinforce the interconnection of the removable gear segment 75 with the remainder of the gear assembly 65, the end wall 70 may be provided with one or more projections 77 (FIGS. 4A, 4B, and 4C) that interlock with correspondingly formed axial slots 77′ (FIG. 4) in the removable end wall portion 74. The removable rim portion 73 is sized and contoured to fill the gap 76 formed in the rim 69. Furthermore, the removable rim portion 73 includes a gear portion 78 that coincides with the gear surface 68 on either side of the gap 76 formed by rim edges such that an uninterrupted gear surface 68 is provided when the removable gear segment 75 is assembled.

To further reinforce the interconnection of the removable gear segment 75 with the remainder of the gear assembly 65, the hub halves 66A, 66B include mating surfaces 80 and 81, respectively, which interface with one another when the gear assembly 65 is assembled. As seen in FIGS. 4A and 4B, the mating surface 81 is facing upward, is formed on either side of the bore 67, and is disposed on the interior side and exterior side of the end wall 70. As seen in FIG. 4C, the mating surface 80 is facing downward, is also formed on either side of the bore 67, and is disposed on the interior side and exterior side of the removable end wall portion 74. Furthermore, the hub half 66A includes lips 82 formed on the interior side of the removable end wall portion 74, and the hub half 66B includes lips 83 formed on the exterior side of the end wall 70. The mating surface 80 is formed partially along the lips 82, and the mating surface 81 is formed partially along the lips 83. As discussed below, the lips 82, 83 are used in joining hub halves 66A, 66B together.

An integral clamping assembly, generally indicated by the numeral 86 FIGS. 4A, 4B, and 4C, is formed as part of the hub 66 to join the hub halves 66A, 66B together. In doing so, the clamping assembly 86 serves in joining the removable gear segment 75 to the remainder of the gear assembly 65. Due to the separation of the hub 66 into halves 66A, 66B, the clamping assembly 86 is similarly divided. The clamping assembly 86 includes two receivers 88 formed in the hub half 66A on either side of the bore 67 to receive lips 83, and two receivers 89 formed adjacent the mating surface 81 on either side of the bore 67 on hub half 66B to receive lips 82.

The receivers 89 are formed on the interior side of the end wall 70, and are configured, when the removable gear segment 75 is assembled with the remainder of the gear assembly 65, to receive the lips 82. To aid in securing the removable gear segment 75 to the gear assembly 65, the lips 82 and receivers 89 include tapers that expand from their axial extremities along the bore 67 to the removable end wall portion 74 and end wall 70, respectively. In particular, the lips 80 include sloped surfaces 92 (facing upward in FIGS. 4A and 4B) and the receivers 89 include sloped surfaces 93 (facing downward in FIGS. 4A and 4B) formed opposite the mating surfaces 81 on the interior thereof.

When the lips 82 are inserted into the receivers 89, the sloped surfaces 92 and 93 slide against one another. Slidable movement of the sloped surfaces 92 and 93 with respect to one another generates a clamping force as the lips 82 are inserted into the receivers 89. This clamping force serves to maintain the position of the removable gear segment 75 relative to the gear assembly 65. That is, insertion of the lips 82 into the receivers 89 effectively wedges the sloped surfaces 92 and 93 against one another to produce the clamping forces which maintain the position of the removable gear segment 75 relative to the gear assembly 65. The clamping force increases as the lips 82 are progressively inserted into the receivers 89.

End stops 94 are provided at the inner extremities of the receivers 89 adjacent the mating surfaces 81 to limit insertion of the lips 82 into the receivers 89. The end stops 94 insure that the sloped surfaces 92 and 93 are positioned to generate adequate clamping force, but, at the same time, effectively limit the clamping force so that the lips 82 can be removed from the receivers 89 without damaging the mating components.

The receivers 88 are formed on the exterior side of the removable end wall portion 74, and are configured to receive the lips 83 when the removable gear segment 75 is assembled with the remainder of the gear assembly 65. To aid in securing the removable gear segment 75 to the gear assembly 65, the lips 83 and receivers 88 also include tapers that expand from their axial extremities along the bore 67 to the end wall 70 and removable end wall portion 74, respectively. In particular, the lips 83 include sloped surfaces 96 (facing downward in FIG. 4C), and the receivers 88 include sloped surfaces 97 (facing upward in FIG. 4B). The receivers 88, as seen in FIG. 4B, have C-shaped cross-sections with the sloped surfaces 97 being formed opposite the mating surfaces 80 on the interior thereof.

When the lips 83 are inserted into the receivers 88, the sloped surfaces 96 and 97 slide against one another. Slidable movement of the sloped surfaces 96 and 97 with respect to one another generates a clamping force as the lips 83 are inserted into the receivers 88. This clamping force serves in maintaining the position of the removable gear segment 75 relative to the gear assembly 65 by wedging the sloped surfaces 96 and 97 against one another. The clamping force increases as the lips 83 are progressively inserted into the receivers 88.

End stops 98 are provided at the extremities of the receivers 88 adjacent the mating surface 80 to limit insertion of the lips 83 into the receivers 88. The end stops 98 insure that the sloped surfaces 96 and 97 are positioned to generate adequate clamping force, but, simultaneously, effectively limit the clamping force so that the lips 83 can be removed from the receivers 88 without damaging the mating components.

Once lips 82 are inserted into receivers 89 and lips 83 are inserted into receivers 88 to effectuate the attachment of the removable gear segment 75 to the gear assembly 65, the security of such attachment may be maintained by using fasteners 100. To this end, threaded apertures 101 are provided in the end wall 70 adjacent the rim 69 of the gear assembly 65, and apertures 102 are provided through the removable end wall portion 74 adjacent the removable rim portion 73 of the removable gear segment 75.

After the gear assembly 65 has been assembled around the drive tube 27, the gear assembly 65 can be secured to the drive tube 27. To that end, a projection 104 is formed integrally with one of the hub halves 66A, 66B. As seen in FIGS. 4A, 4B, and 4C, the projection 104 extends downwardly from the hub half 66B, and includes a threaded aperture 105 for receiving a locking fastener 106. When fully inserted into the aperture 105, the locking fastener 106 bears on the drive tube 27. In doing so, the locking fastener 106 secures the attachment of the gear assembly 65 to the drive tube 27.

For example, the locking fastener 106 is purposely long enough to impinge the drive tube 27, and, upon complete insertion into the threaded aperture 105, to slightly deform the drive tube 27 in the area generally indicated by the numeral 110 to form recess 111. The impingement of the locking fastener 106 against the drive tube 27 forces the drive tube 27 against the hub half 66A to effectively clamp the drive tube 27 to the gear assembly 65. Furthermore, the recess 111 formed by the slight deformation of the drive tube 27 partially envelops the locking fastener 106, and, in doing so, serves in preventing axial movement of the gear assembly 65 along the drive tube 27, and in preventing relative rotational movement of the gear assembly 65 around the drive tube 27 in order to accommodate the torque requirements necessary to effect actuation of the drive tube 27.

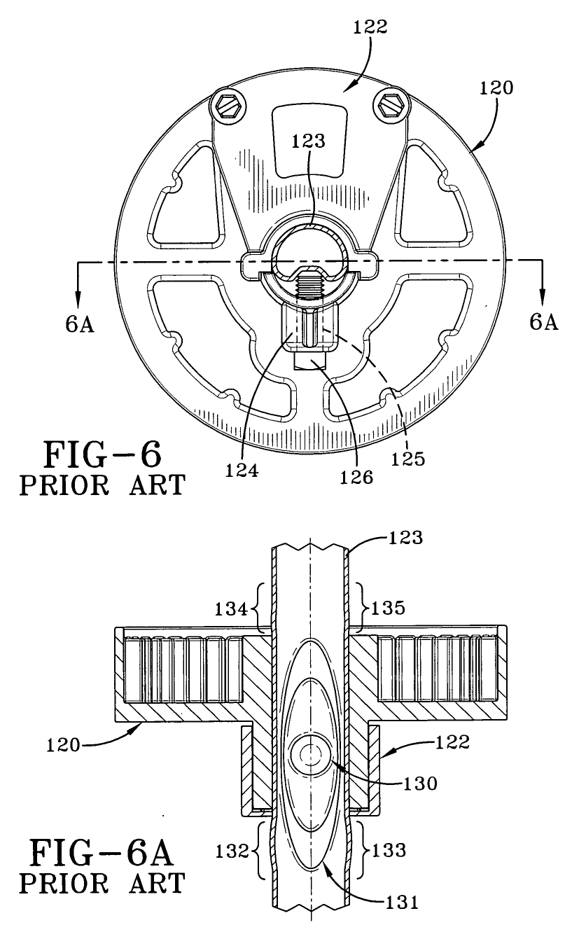

The length of the locking fastener 106 is predetermined to limit the amount of force applied against the drive tube 27, thereby limiting the resulting depth of the recess 111 formed at 110 to prevent collapse of the drive tube 27 as associated with the prior art depicted in FIGS. 6 and 6A. That is, by limiting the depth of recess 111 by providing the locking fastener 106 with a predetermined length, unwanted collapse of the drive tube 27 beyond a localized area can be prevented. As such, when the locking fastener 106 is inserted into the aperture 105, the locking fastener head 106′ engages projection 104 before causing a degree of deformation which collapses the drive tube 27.

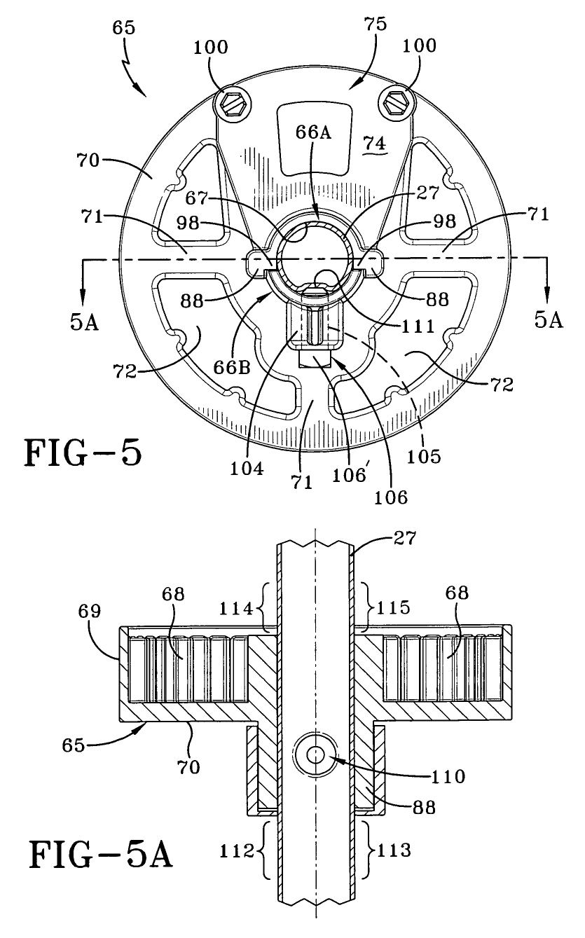

Limiting the depth of the recess 111 by only slightly deforming the drive tube 27 also prevents enlargement of the drive tube 27 at the areas generally indicated by the numerals 112, 113, 114 and 115 in FIG. 5A. By preventing bulging of the drive tube 27 around its perimeter and along its axial length adjacent the gear assembly 65 at areas 112, 113, 114 and 115, the gear assembly 65 can, after its initial attachment to the drive tube 26, be repositioned axially along the drive tube 27 without interference.

The attachment of the gear assembly 65 to the drive tube 27 allows for sufficient operating torque to be transferred to the drive tube 27 from the operator 35, but does not deform the drive tube 27 such that the gear assembly 65 cannot be removed therefrom. That is, while the depth of the recess 111 is limited during the attachment of the gear assembly 65 to the drive tube 27, such attachment allows sufficient operating torque to be applied to the drive tube 27, but, simultaneously, prevents unwanted collapse of the drive tube 27. Through experimentation, it has been found that about 75 inch pounds of torque applied to the locking fastener 106 generates force against the drive tube 27 that allows for sufficient attachment of the gear assembly 65 to the drive tube 27, but that such force is not of a magnitude that collapses the drive tube 27.

In addition to the gear assembly 65, components such as spring perches, torsion spring winding cones, and cable storage drums can be attached to the drive tube 27 in a similar fashion. That is, locking fasteners can be applied through apertures formed in these components against the drive tube 27 such that the depth of recess formed along the drive tube 27 is limited. Again, by limiting the amount of force applied by the locking fastener against the drive tube 27, the attachment of these components to the drive tube 27 will allow sufficient operating torque to be applied to the drive tube 27, but, simultaneously, prevent unwanted collapse of the drive tube 27. By limiting the depths of the recesses formed by the fasteners against the drive tube 27, rotational forces can transferred between these components and the drive tube 27 without the drive tube 27 being deformed to an extent that prohibits these components from being removed therefrom.

Thus, it should be evident that the door operator drive system disclosed herein carries out one or more of the objects of the present invention set forth above and otherwise constitutes an advantageous contribution to the art. As will be apparent to persons skilled in the art, modifications can be made to the preferred embodiment disclosed herein without departing from the spirit of the invention, the scope of the invention herein being limited solely by the scope of the attached claims.

1. A drive system for a door comprising, an operator, a counterbalance system, a drive tube of the counterbalance system interconnecting said operator and the door, a gear assembly of said operator engaging said drive tube for transferring rotational forces from said operator to said drive tube, an aperture extending through said gear assembly, and a fastener in said aperture extending through said gear assembly and deforming said drive tube sufficient to permit transfer of operating torque of said operator to said drive tube, but not to an extent preventing said gear assembly from being removed therefrom from said drive tube.

2. A drive system according to claim 1, wherein said fastener forms a localized recess.

3. A drive system according to claim 1, wherein approximately 75 inch pounds of torque is applied to said fastener to attach said gear assembly to said drive tube.

4. A combination drive tube and operator, comprising an operator, a drive tube extending outwardly of said operator, said operator having a motor assembly, at least one gear assembly operatively interconnected with said motor assembly, wherein said at least one gear assembly includes a bore extending therethrough adapted to receive the drive tube, and an aperture extending therethrough adapted to receive a locking fastener, said locking fastener impinging said drive tube when fully inserted into said aperture, and having a length preventing generation of a force against the drive tube causing enlargement thereof adjacent said at least one gear assembly.

5. A combination according to claim 4, wherein said locking fastener has a length preventing collapse of the drive tube which causes bulging around the perimeter and along the axial length of the drive tube directly adjacent said at least one gear assembly.

6. A combination according to claim 4, wherein said locking fastener impinges against the drive tube to secure the position of the drive tube relative to the operator.

7. A combination according to claim 6, wherein, when said locking fastener has been removed from said aperture, said at least one gear assembly can be axially repositioned along the drive tube.

8. A combination according to claim 7, wherein said motor assembly includes a drive gear engageable with a gear surface formed on said gear assembly.

9. A combination according to claim 8, wherein said at least one gear assembly includes an outer rim, said gear surface being formed interiorly of said outer rim, said drive gear engaging said gear surface.

10. A combination according to claim 7, wherein said at least one gear assembly includes a removable gear segment that is removable to radially open said at least one gear assembly to allow insertion of the drive tube into said bore.

11. A method for attaching a gear assembly of a door operator to a drive tube, comprising, assembling the gear assembly around the drive tube, locating the gear assembly on the drive tube, providing an aperture in the gear assembly to receive a locking fastener, limiting the length of the locking fastener to prevent generation of a force against the drive tube causing enlargement of the drive tube adjacent the gear assembly, inserting the locking fastener into the aperture, and impinging the drive tube with the locking fastener to secure the position of the gear assembly relative to the drive tube.

12. A method of attaching a component on a hollow drive tube of a counterbalance system for a door comprising, mounting the component on the drive tube, providing an aperture in the component, inserting a locking fastener in the aperture that extends through the aperture and engages the drive tube to transmit rotational forces between the component and the drive tube, and limiting the amount the locking fastener extends through the component so that the drive tube is not deformed to an extent the component cannot be removed from the drive tube.

13. A method according to claim 12 including the step of inserting the locking fastener through the component a sufficient distance to form a recess in said drive tube.

14. A method according to claim 12, including the step of threading the locking fastener in the aperture.

15. A method according to claim 14, including the step of providing a head on the locking fastener that engages the component for limiting the amount the locking fastener extends through the component.
